(19) United States
(12) Patent Application Publication
(10) Pub. No.: US 2026/0214287 A1
(43) Pub. Date: Jul. 23, 2026

(54) SERVER DEVICE, DISPLAY DEVICE, AND PROGRAM

(71) Applicant: RADIUS CO., LTD., Tokyo (JP)

(72) Inventor: Susumu KOHDA, Tokyo (JP)

(73) Assignee: RADIUS CO., LTD., Tokyo (JP)

(21) Appl. No.: 19/136,033

(22) PCT Filed: Mar. 2, 2023
(86) PCT No.: PCT/JP2023/007787

§ 371 Date: Jun. 5, 2025

(30) Foreign Application Priority Data
Dec. 9, 2022 (WO) PCT/JP2022/045565

(51) Int. Cl. H04N 21/266; H04N 21/218; H04N 21/2347; H04N 21/4223; H04N 21/442; H04N 21/482; H04N 21/84

(52) U.S. Cl. CPC H04N 21/266; H04N 21/21805; H04N 21/2347; H04N 21/4223; H04N 21/44236; H04N 21/482; H04N 21/84

(57) ABSTRACT

Provided is a device configured to be capable of switching channels of videos when the videos included in a content associated with an identification code are played. A server device (10) of an aspect of the present invention includes: an acquisition section (111) that acquires an identification code associated with a content including videos of a plurality of channels and information for identifying an external device (20) which is a transmission source of the identification code; and a communication section (13) that transmits, when authentication using the identification code has been carried out, a first channel video included in the content to the identified external device (20), the communication section (13) transmitting, in response to a user operation via the external device (20), a second channel video included in the content to the external device (20).

### TECHNICAL FIELD

The present invention relates to a server device, a display device, and a control program.

### BACKGROUND ART

As a conventional technique, a service is known in which, in a case where an identification code that is associated with a predetermined content is input to a display device that is owned by a user and authentication using the identification code is carried out, the content is downloaded to the display device so that the content can be played. Patent Literature 1 discloses an information provision system in which a serial number is input and a complementary music file is downloaded to a user terminal device and indicates that the information provision system is applicable to provision of video information.

### CITATION LIST cl Patent Literature 1

Japanese Patent Application Publication Tokukai No. 2002-14683

### SUMMARY OF INVENTION

### Technical Problem

However, the above described conventional technique has a problem that it is impossible to switch channels of a video in a case where the video included in a certain content is played.

An aspect of the present invention is accomplished in view of the above problem, and provides a device configured to be capable of switching channels of videos in a case where the videos included in a content associated with an identification code are played.

### Solution to Problem

In order to attain the object, a server device in accordance with an aspect of the present invention includes: an acquisition section that acquires (i) an identification code which is associated with a content including videos of a plurality of channels and (ii) information for identifying an external device which is a transmission source of the identification code; and a communication section that transmits, in a case where authentication using the identification code has been carried out, a first channel video included in the content to the external device which has been identified, the communication section transmitting, in response to a user operation via the external device, a second channel video included in the content to the external device.

In order to attain the object, a display device in accordance with an aspect of the present invention includes: a display section; an input section that is used to input an identification code which is associated with a content including videos of a plurality of channels; a communication section that transmits, to a server device, the identification code which has been input and information for identifying the display device; and a display control section that, in a case where authentication using the identification code has been carried out, causes the display section to display a first channel video which is included in the content and which has been transmitted from the server device, the display control section, in response to a user operation via the input section, causing the display section to display a second channel video which is included in the content and which has been transmitted from the server device.

The server device and the display device in accordance with each of the aspects of the present invention can each be implemented by a computer. In such a case, the present invention encompasses (i) a control program of the server device or display device which control program causes the computer to serve as the sections (software elements) included in the server device or display device for implementing the server device or display device and (ii) a computer-readable storage medium storing the control program.

### Advantageous Effects of Invention

According to an aspect of the present invention, it is possible to provide a device configured to be capable of switching channels of videos in a case where the videos included in a content associated with an identification code are played.

### BRIEF DESCRIPTION OF DRAWINGS

FIG. 1 is an example of a block diagram illustrating a functional configuration of a system.

FIG. 2 is an example of a table which is stored in a storage section of a server device.

FIG. 3 is an example of a sequence diagram illustrating a flow of a process in accordance with a process example of a system.

FIG. 4 is an example of an identification code input screen and a content list screen in an application.

FIG. 5 is an example of a flowchart corresponding to a process of displaying a video in S105.

FIG. 6 is an example of a screen in a case where an application prohibits playing of a video and audio.

FIG. 7 is an example of a video displayed on a display section.

### DESCRIPTION OF EMBODIMENTS

The following description will discuss details of an embodiment of the present invention.

### 1. Example Configuration of System 1

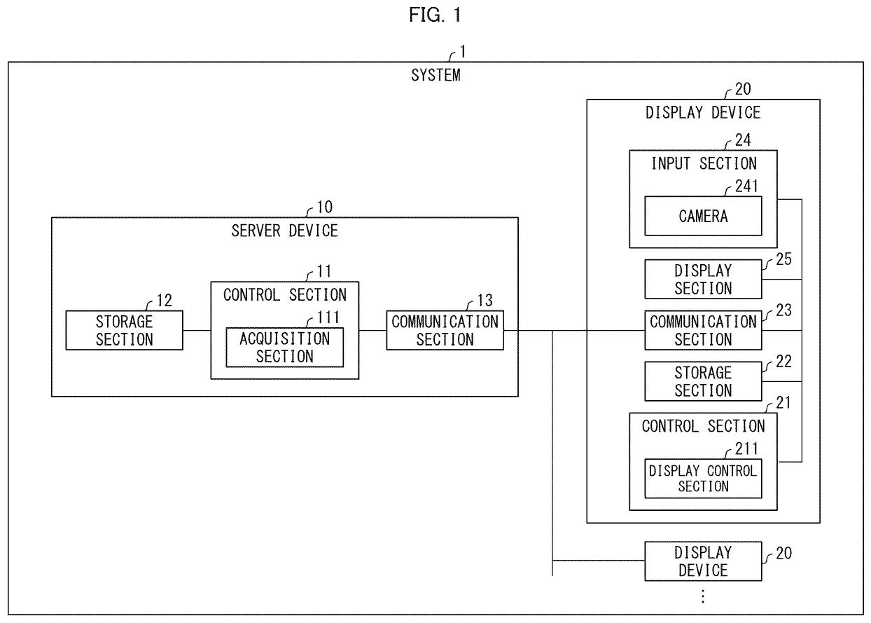

FIG. 1 is an example of a block diagram illustrating a functional configuration of a system 1 in accordance with the present disclosure. The system 1 is a system for transmitting a video included in an arbitrary content from a server device 10 to a display device (external device) 20 and playing the video. In many cases, one or more channels of audio included in a content is associated with a video, and the display device 20 plays the audio in parallel with the video. In the present disclosure, a content is explained as including videos of a plurality of channels. Note, however, that the present disclosure is not necessarily limited to this. On the display device 20, a user can select and play a video of an arbitrary channel.

The system 1 includes a server device 10 and one or more display devices 20. The server device 10 is a device that functions as a server for supplying contents, and includes a control section 11, a storage section 12, and a communication section 13.

The control section 11 is a control device that collectively controls the entire server device 10 and includes an acquisition section 111. The acquisition section 111 acquires (i) an identification code which is associated with a content including videos of a plurality of channels and (ii) information for identifying a display device 20 which is a transmission source of the identification code. In the present disclosure, the above described content including the video is simply referred to also as a “video content”.

The identification code is a serial code (serial number) including alphanumeric characters and symbols for identifying a content. The identification code may be configured to be sold for a fee or may be configured to be provided for free. A single identification code may be associated with a plurality of contents (details will be described later). This means that a user can download a plurality of contents by inputting a single identification code to the display device 20. Alternatively, a single content may be associated with a plurality of types of identification codes.

The storage section 12 is a storage device that stores various pieces of information, and stores, for example, a table indicating a correspondence between contents and identification codes. The control section 11 carries out authentication using an identification code which has been acquired by the acquisition section 111 with reference to the table. From a different point of view, authentication is a process of determining that the identification code which has been acquired by the acquisition section 111 is valid.

The communication section 13 is an interface that carries out a communication process with the display device 20 or the like based on control by the control section 11. For example, the communication section 13 transmits a video of one of channels to the display device 20. The communication section 13 may transmit the video to the display device 20 by streaming transmission, or may transmit the video at a time so that the video is stored as chunk data in the display device 20. Streaming reception by the display device 20 is a type of downloading. Even in a case where the display device 20 plays a video stored in the storage section 22 and streaming reception is not carried out, authentication using an identification code is carried out before playing the video.

It is preferable to employ a configuration in which data such as a video which is transmitted between the server device 10 and the display device 20 is transmitted after being encrypted and then decrypted in a device which has received the data.

The display device 20 is a device capable of outputting a video and audio, and can be implemented, for example, as a smart phone, a tablet, a personal computer, a television, a game machine, or the like. The display device 20 includes a control section 21, a storage section 22, a communication section 23, an input section 24, and a display section 25.

The control section 21 is a control device that controls the entire display device 20 and includes a display control section 211. The display control section 211 carries out control related to screen display on the display section 25. For example, the display control section 211 causes the display section 25 to display a video input from the server device 10 to the display device 20.

The storage section 22 is a storage device that stores various pieces of information and stores, for example, an identification code which has already been authenticated and information for identifying a content associated with the identification code. Here, the information for identifying a content may be, for example, an ID of the content or may be an identification code which is associated with the content. The display device 20 may have a configuration in which an application for playing a video and audio is installed. In this configuration, data of the application is stored in the storage section 22.

The communication section 23 is an interface that carries out a communication process with the server device 10 or the like based on control by the control section 21. For example, the communication section 23 transmits, to the server device 10, information for identifying a content selected by the user via the input section 24.

The input section 24 is a member used by a user to input information to the display device 20, and can be implemented, for example, as a keyboard or other buttons or a mouse. The input section 24 may be a remote controller, a controller, or the like of another device which is different from the display device 20 itself. The user carries out an input operation of an identification code or the like and various selection operations via the input section 24. The input section 24 and the display section 25 may be configured to be implemented as an integrated touch panel.

As illustrated in FIG. 1, the input section 24 may include a camera 241 that captures an image. A configuration may be employed in which a two-dimensional code indicating an identification code can be read by the camera 241. Thus, it is possible to reduce labor of a user to input an identification code.

The display section 25 is a display panel which displays a video, a character string, an object, or the like, based on control by the display control section 211.

Note that functions of a single member included in the system 1 may be implemented by a plurality of other members, and functions of a plurality of members included in the system 1 may be implemented by another single member. For example, the system 1 may include a plurality of server devices 10, or may be configured such that authentication of an identification code described above is carried out by an authentication device different from the server device 10. Some members included in the system 1 may be configured to be detachable from the server device 10 or the display device 20.

According to the configuration illustrated in FIG. 1, it is possible to provide a device configured to be capable of switching channels of videos in a case where the videos included in a content associated with an identification code are played.

### 2. Example of Table for Authentication

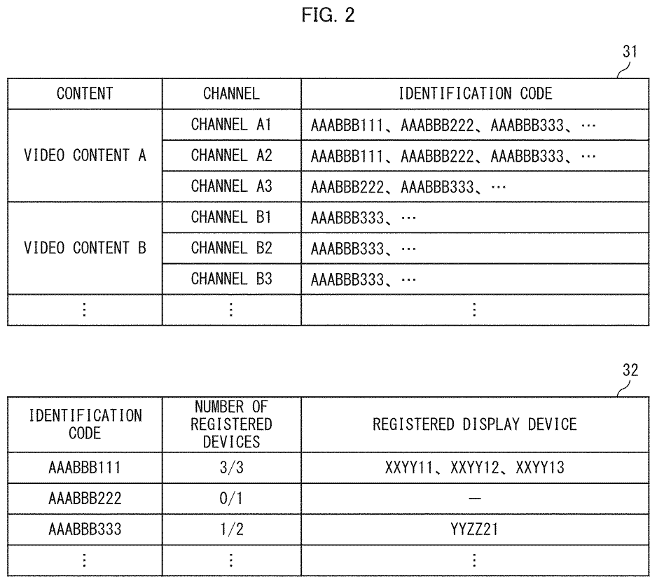

The following description will discuss the above described table which is stored in the storage section 12 of the server device 10, with reference to specific examples. Table 31 in FIG. 2 is a table showing an example of a table indicating a correspondence between contents and identification codes.

For example, Table 31 indicates that a video content A includes videos of channels A1 through A3 and a video content B includes videos of channels B1 through B3, and the like. Values in an “identification code” column indicate which identification code needs to be used for authentication in order to download a video of a corresponding channel to the display device 20. For example, in order to download the video of the channel A3 to the display device 20, authentication using an identification code “AAABBB222” or “AAABBB333” is needed, and even if authentication using an identification code “AAABBB111” is carried out, the video of the channel A3 cannot be downloaded.

A content may be associated with a plurality of types of identification codes and include one or more channel videos which are prescribed for each type of identification code. For example, the video content A is associated with (i) a first type identification code for enabling downloading of only videos of the channels A1 and A2 and (ii) a second type identification code for enabling downloading of videos of the channels A1 through A3.

A single identification code may be associated with a plurality of contents, and at least one of the plurality of contents may include videos of a plurality of channels. For example, in a case where authentication using the identification code “AAABBB333” has been carried out, the display device 20 which is a transmission source of the identification code can download the video content A and the video content B. It is preferable that an actual identification code is a more complicated character string than that exemplified in FIG. 2.

Videos of channels included in a certain content may be identical to each other, or configured to have the same content and differ only in a video format or bit rate, or may differ in content from each other. In a case where at least videos of channels are identical to each other, typically, pieces of audio associated with the respective videos differ in content from each other, or audio formats or bit rates of the pieces of audio differ from each other. In one aspect, it is possible that, among videos of channels included in a certain content, at least two videos differ from each other and pieces of audio associated with the at least two videos differ from each other.

In one aspect, a configuration may be employed in which, among videos of channels which are included in a certain content, videos of at least two channels have been obtained by imaging a part or whole of a particular subject from different positions and are respectively associated with pieces of audio corresponding to imaging positions. Here, audio corresponding to an imaging position is, for example, audio which has been collected at the imaging position or audio which is reproduction of the collected audio. Audio corresponding to an imaging position may be immersive audio, such as Dolby Atmos (registered trademark), Auro-3D (registered trademark), 360 Reality Audio (registered trademark), or spatial audio.

Thus, for example, in a case where a content is a live video of a singer, it is possible to reproduce, for respective channels, videos viewed from positions of different seats and pieces of audio audible at the positions. For example, a video of a certain channel may be a video obtained by shooting all members of a singer group as an entire subject, and a video of another channel may be a video obtained by shooting a member of the singer group as a part of the subject.

In one aspect, a configuration may be employed in which a selling price of an identification code for enabling playing of a video of a channel viewed from a seat position close to a singer who is a subject is higher than a selling price of an identification code for enabling playing of only a video of a channel viewed from a far seat position.

Table 32 is an example of a table indicating a correspondence between identification codes and display devices 20 which are registered by authentication using the identification codes.

In Table 32, a denominator of values in the “number of registered devices” column indicates a maximum number of display devices 20 which can be registered by authentication using a corresponding identification code. The term “registration” of the display device 20 means that a display device 20 which is a transmission source of an identification code is stored as a display device 20 which can download a content associated with the identification code. In some cases, the denominator is 2 or more. As indicated in such a case, a configuration may be employed in which a single identification code is input to each of a plurality of display devices 20, and a content can be downloaded to each of the display devices 20.

A numerator of values in the “number of registered devices” column indicates how many display devices 20 are registered, at the present time, by authentication using an identification code of interest. For example, in a case of the identification code “AAABBB111”, three display devices 20 which are the maximum number have already been registered. Therefore, even if the identification code “AAABBB111” is input to another new display device 20, the display device 20 is not registered. It is preferable to employ a configuration in which registration of a display device 20 can be cancelled by an operation or the like via an input section 24 of the display device 20. Thus, even in a case where the number of devices which can be registered using a certain identification code has been reached, it is possible to switch display devices 20 which can download a content.

Values in the “registered display device” column are each a value (such as a MAC address) for uniquely identifying an individual display device 20, and each indicate a display device 20 which has been registered by authentication using a corresponding identification code.

As described above, the storage section 12 of the server device 10 stores one or more authenticated identification codes and information for identifying one or more display devices 20 in association with each other. In a case where the acquisition section 111 has acquired information for identifying a display device 20, a process related to authentication is carried out using an identification code which is stored in the storage section 12 and is associated with the information for identifying the display device 20. Here, the process related to the authentication can include, for example, authentication using the server device 10 alone or authentication using another authentication device described above.

It is possible to employ a configuration in which an expiration date is set for an identification code. In the configuration, the storage section 12 stores, in association with an identification code, an expiration date of the identification code. For example, the expiration date may be defined by a period from a time when the identification code is first used for authentication. Alternatively, a date and time at which the identification code becomes invalid may be set in advance. For a single identification code, different expiration dates may be set for respective contents or for respective channels. In a case where a content is a real-time live video or a recorded live video, an identification code may be configured to be valid only during live distribution.

### 3. Process Example of System 1

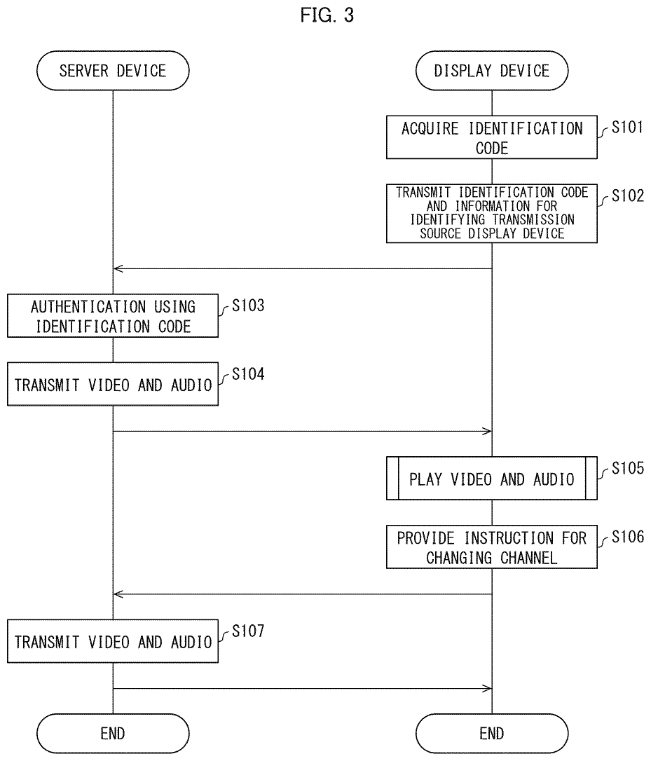

The following description will discuss a flow of a process which is carried out by the system 1, with reference to an example. FIG. 3 is an example of a sequence diagram illustrating a flow of a process in accordance with this example.

In S101 (step S101), the control section 21 of the display device 20 acquires an identification code which has been input by a user via the input section 24. In this example, it is assumed that input of an identification code described above and playing of a video and audio which will be described later are carried out using an application installed in the display device 20.

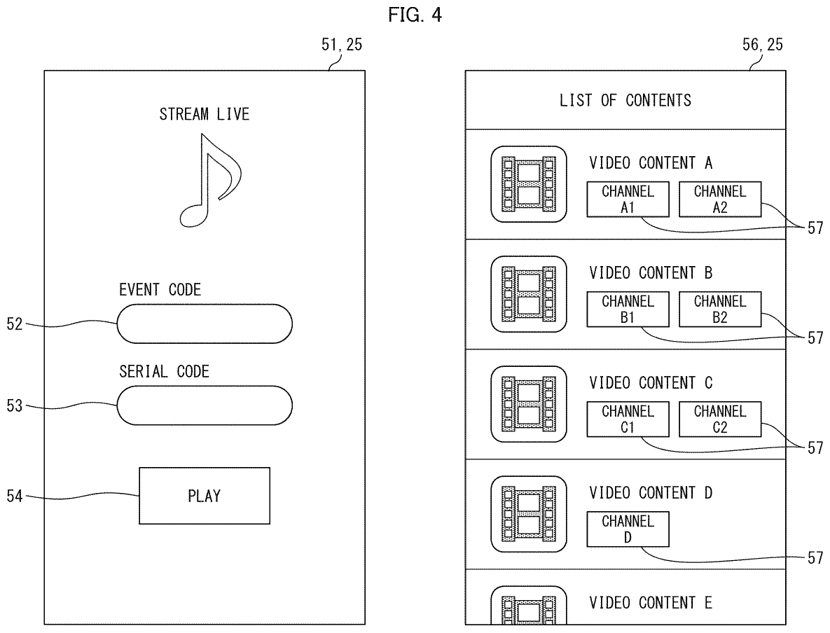

A screen 51 in FIG. 4 is a screen of the application and shows an example of an identification code input screen. On the screen 51, input forms 52 and 53 are each an input form for inputting an identification code.

In the example of the screen 51, a content is a video of an event such as a live concert, and the input form 52 is a form for inputting a character string for identifying the event. An “event code” which is input to the input form 52 may be a common value for each event. The input form 53 is a form for inputting “serial codes” which are individually different from each other.

As exemplified by the input forms 52 and 53, a single identification code may be configured to include two or more character strings. Alternatively, for example, among the above described “event code” and “serial code”, only the “serial code” may be dealt with as an identification code.

According to such a configuration of the present disclosure, as exemplified by the screen 51, it does not necessarily need to input personal information and carry out member registration when a user downloads a content.

In S102, the control section 21 transmits the input identification code and information for identifying a transmission source display device to the server device 10 via the communication section 23. In the example of the screen 51, in a case where a button 54 has been pressed, the process of this step S102 is carried out.

In S103, the acquisition section 111 of the server device 10 acquires pieces of information received via the communication section 13, and the control section 11 carries out authentication using the identification code. In a case where the authentication is successful, a process of S104 is subsequently carried out. The control section 11 registers, in the storage section 12, a display device 20 which is a transmission source of the identification code as a “registered display device” as exemplified in Table 32 in FIG. 2, in association with the identification code.

In this step S103, the control section 11 identifies whether at least the display section 25 of the display device 20 has a longitudinally-long screen or a horizontally-long screen. More preferably, the control section 11 identifies a screen size of the display section 25 of the display device 20.

For example, in a case where information acquired by the acquisition section 111 includes information indicating that an identification code or the like has been transmitted via an application for a smart phone or tablet, the control section 11 determines that the display section 25 has a longitudinally-long screen. This is because, typically, a smart phone is used in an orientation in which a longer side of a display is a vertical side. Meanwhile, in a case where information acquired by the acquisition section 111 includes information indicating that an identification code or the like has been transmitted via an application for a personal computer, the control section 11 determines that the display section 25 has a horizontally-long screen. This is because, typically, a personal computer is used in an orientation in which a shorter side of a display is a vertical side.

Alternatively, in a case where the above information for identifying the transmission source display device includes information for identifying a screen size of the display section 25 or information for identifying a model of the display device 20, the control section 11 may be configured to identify the screen size of the display section 25 with reference to these pieces of information.

In S104, the control section 11 transmits, via the communication section 13, a video and audio of a content associated with the identification code used for authentication to the display device 20. In a case where there are a plurality of contents which are associated with the identification code used for authentication or there are a plurality of videos of channels included in the contents, a video of a channel which is first transmitted as a default may be prescribed. The video transmitted to the display device 20 in this step S104 is an example of the first channel video in the present disclosure. That is, in a case where authentication using an identification code has been carried out, the communication section 13 transmits, to the identified display device 20, a first channel video included in the content.

In this step S104, in a case where it has been identified that the display device 20 has a longitudinally-long screen, the communication section 13 transmits, to the display device 20, a longitudinally-long video for full screen display on the display device 20. Here, the longitudinally-long video is a video which has been created to be played on a vertical screen.

In a case where authentication using the identification code has not been successful, the control section 11 transmits, to the display device 20, information indicating that authentication has not been successful, without transmitting a video and audio. Here, the case where authentication using the identification code is not successful may be a case where there is an error in the identification code, or a case where the number of registered devices has reached an upper limit.

In S105, the display control section 211 of the display device 20 carries out a process of causing the display section 25 to display a video of the content received by the communication section 23. That is, in a case where authentication using the identification code has been carried out, the display control section 211 causes the display section 25 to display a first channel video which is included in the content and which has been transmitted from the server device 10. In addition, the control section 21 plays audio included in the content. Moreover, the control section 21 causes the storage section 22 to store information for identifying the content which is associated with the identification code which has been successfully authenticated.

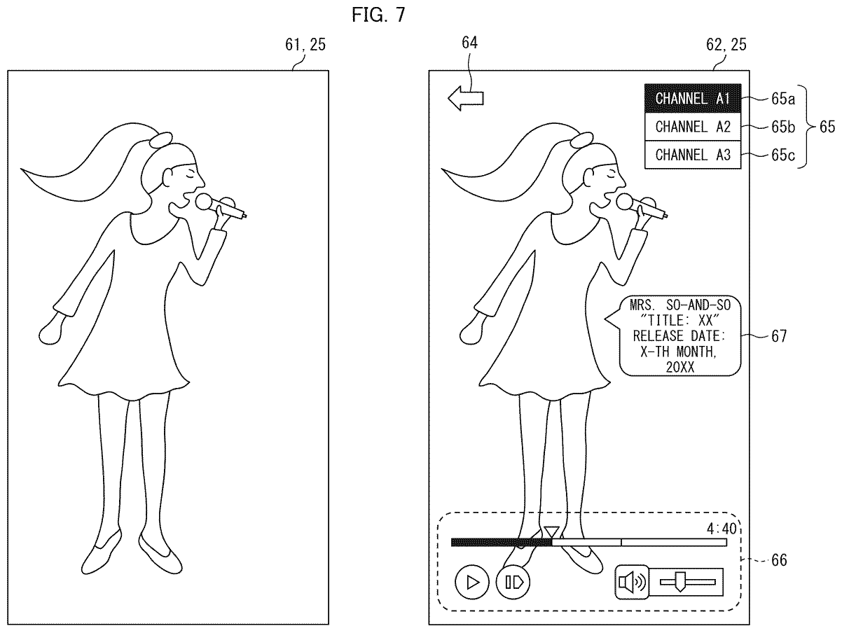

Screens 61 and 62 in FIG. 7 each show an example of a video displayed on the display section 25 in this step S105. The video displayed on the display section 25 may be a longitudinally-long video as illustrated in FIG. 7 or may be a horizontally-long video. Typically, however, in order to display a longitudinally-long video on a full screen, an application needs to be compatible with full screen display of videos. In the video illustrated in FIG. 7, audio played along with the video may be immersive audio such as Dolby Atmos. From a different point of view, the communication section 13 may transmit, to the display device 20 in S104 described above, audio which is associated with audio compatible with immersive audio.

In the screen 61 in FIG. 7, in a case where a selection is made by tapping or the like in the screen, objects indicated in the screen 62 are displayed. In the screen 62, an object 64 is a button for returning to a screen immediately before playing a video. An object 65 indicates a channel that can be played. In the screen 62, the object 65 indicates that a video of “channel A1” is displayed. Even in a case where full screen display of a video of any channel is carried out, it is not essential that full screen display is carried out for a video of any other channel. An object 66 is an interface for operating a play position, volume, and the like. Further, in a case where a place where no object is displayed is selected in the screen 62, the screen returns to the display of the screen 61.

An object 67 is an object indicating details of the content, a performer, or the like. For example, in S104, information included in the object 67 is transmitted to the display device 20 together with the video and audio by the control section 11. A configuration may be employed in which it is possible, when a user has selected the object 67 or text in the object 67, to make a transition to an external website or the like pertaining to the content which is being displayed.

In S106, in a case where an operation of the user to change a channel of a video to be played is carried out via the input section 24, the control section 21 transmits, to the server device 10, information indicating the designated channel. Selection of the object 65b or 65c in the screen 62 is an example of a user operation for changing a channel of a video to be played.

A candidate for a channel which can be changed is a channel corresponding to an authenticated identification code. From a different point of view, the communication section 13 is configured to transmit, to the display device 20, a video of any channel among one or more channel videos corresponding to a type of the authenticated identification code.

In S107, the control section 11 transmits, to the display device 20, a video and audio of the designated channel. The video transmitted to the display device 20 in this step S107 is an example of the second channel video in the present disclosure. That is, in response to a user operation via the display device 20, the communication section 13 transmits, to the display device 20, a second channel video included in the content. On the display device 20, the video and audio of the channel are played. That is, in response to a user operation via the input section 24, the display control section 211 causes the display section 25 to display the second channel video which is included in the content and which has been transmitted from the server device 10.

Note that a horizontally-long video may be played on a smart phone or tablet in a full screen or part of the display section 25, or a longitudinally-long screen may be played on a personal computer. A part of the screen where a video is not displayed is, for example, filled with black. An object for switching between a longitudinally-long video and a horizontally-long video may be included in, for example, the screen 62 in FIG. 7. In a case where the object is selected, the control section 11 transmits, to the display device 20, a video which has been switched from longitudinally-long to horizontally-long or from horizontally-long to longitudinally-long.

The flow of the process based on the sequence diagram in FIG. 3 has been described above. In place of the process in S101, the display control section 211 may cause the display section 25 to display a list of contents which are associated with an authenticated identification code and the control section 21 may identify, from among the contents included in the list, a content selected via the input section 24. In this case, in S102, the communication section 23 transmits, to the server device 10, information for identifying the display device 20 which is the transmission source device and information for identifying the selected content. In S103, the control section 11 of the server device 10 authenticates that the identified display device 20 has been registered using the identification code associated with the selected content. According to the above configuration, it is not necessary to input an identification code which has been successfully authenticated once to the input section 24 again, and thus it is possible to reduce labor of a user.

A screen 56 in FIG. 4 indicates an example of a screen of the above described application and a list screen of contents which are associated with an authenticated identification code. In the above screen, as exemplified by buttons 57, a configuration may be employed in which a channel to be played first can be directly designated.

It is possible to employ a configuration in which a plurality of chapters are set in a video of each channel at constant or arbitrary time intervals, and a play position can be jumped to the beginning of a chapter selected from the list by a user. This configuration is not limited to the case where the display device 20 downloads and stores a video, and the same applies to a case where streaming reception is carried out. The above configuration is implemented as follows: that is, the control section 11 of the server device 10 transmits, to the display device 20, information indicating a list of chapters which is stored in the storage section 12, and the control section 21 of the display device 20 reads, from the storage section 22, a video of a chapter selected by a user, or the control section 21 carries out streaming reception from the server device 10.

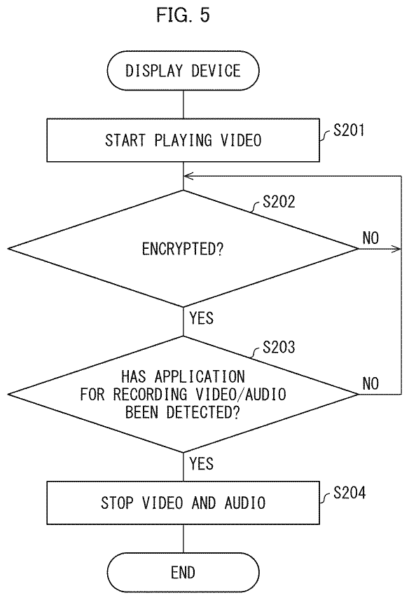

Subsequently, a process of displaying a video in S105 and the like will be supplemented with reference to FIG. 5. FIG. 5 is an example of a flowchart corresponding to the process of displaying a video in S105.

In S201, the display control section 211 starts a process of causing the display section 25 to display a video of a content which has been received by the communication section 23.

In S202, the control section 21 determines whether or not the video and audio included in the content have been encrypted to prohibit recording, i.e., video recording and audio recording on the display device 20. In a case where the control section 21 has determined that the video and audio have been encrypted to prohibit recording on the display device 20 (YES in S202), the control section 21 carries out a process of S203, subsequently.

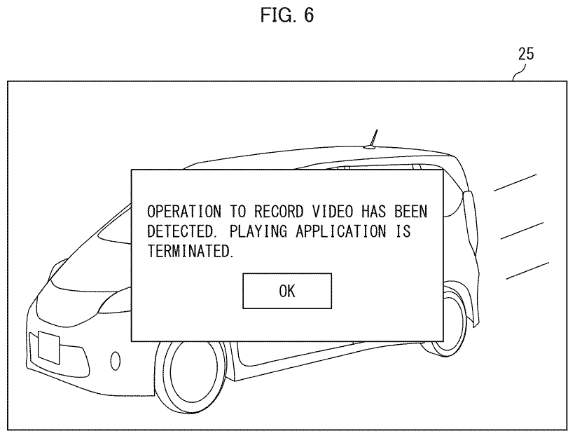

In S203, the control section 21 determines, during playing of the video and audio, whether or not an operation of an application for recording the video and audio has been detected on the display device 20. In a case where the control section 21 has detected that the recording application has been executed (YES in S203), in S204, the application for playing the video and audio stops playing the video and audio. That is, the display device 20 plays, using the application installed in the display device 20, a video and audio transmitted from the server device 10, and the application prohibits playing of the video and audio in a case where it has been detected that a video recording application or audio recording application is executed on the display device 20. FIG. 6 illustrates an example of a screen in a case where the application prohibits playing of a video and audio. In a case where playing of a video and audio is prohibited, it is not essential that a dialog screen as exemplified in FIG. 6 is displayed. For example, it is possible to employ a configuration in which the screen is switched to a screen which is blacked out or a screen to which filtering such as mosaic is applied.

Meanwhile, in a case where the control section 21 has determined that the video and audio included in the content have not been encrypted as described above in S202 (NO in S202) or in a case where an operation of the recording application is not detected in S203 (NO in S203), playing of the video and audio is continued, and the determination from S202 is periodically carried out.

The flow of the process based on the flowchart in FIG. 5 has been described above. Note that it is possible to employ a configuration in which recording of only one of a video and audio included in a content is prohibited.

### 4. Software Implementation Example

Functions of the server device 10 and the display device 20 (hereinafter referred to as a “device”) can be implemented by a program for causing a computer to function as the device, the program causing the computer to function as control blocks (in particular, sections included in the control section 11 and control section 21) of the device.

In this case, the device includes, as hardware for executing the program, a computer including at least one control device (e.g., a processor) and at least one storage device (e.g., a memory). The functions described in the above embodiments are implemented by the program being executed by the control device and the storage device.

The program may be recorded in one or more non-transitory computer-readable recording media. The recording media may be or may not be included in the device. In the latter case, the program may be supplied to the device via any wired or wireless transmission medium.

Furthermore, some or all of functions of the control blocks can also be implemented by a logic circuit. For example, the present invention encompasses, in its scope, an integrated circuit in which a logic circuit that functions as each of the above described control blocks is formed. In addition, the function of each of the control blocks can be implemented by, for example, a quantum computer.

The processes described in the above embodiments may be carried out by artificial intelligence (AI). In this case, AI may be operated in the control device, or may be operated in another device (e.g., an edge computer or a cloud server).

### 5. Aspects of the Present Invention can also be Expressed as Follows

The server device (10) in accordance with aspect 1 of the present invention is configured to include: an acquisition section (111) that acquires (i) an identification code which is associated with a content including videos of a plurality of channels and (ii) information for identifying an external device (20) which is a transmission source of the identification code; and a communication section (13) that transmits, in a case where authentication using the identification code has been carried out, a first channel video included in the content to the external device which has been identified, the communication section transmitting, in response to a user operation via the external device, a second channel video included in the content to the external device. According to the above configuration, it is possible to provide a device configured to be capable of switching channels of videos in a case where the videos included in a content associated with an identification code are played.

The server device in accordance with aspect 2 of the present invention may be configured in the aspect 1 such that: among videos of channels which are transmitted by the communication section, at least two videos differ from each other, and pieces of audio associated with the at least two videos differ from each other. According to the above configuration, it is possible to provide a content in which a video differs and audio differs for each channel.

The server device in accordance with aspect 3 of the present invention may be configured in the aspect 2 such that: among videos of channels which are transmitted by the communication section, videos of at least two channels have been obtained by imaging a part or whole of a particular subject from different positions and are respectively associated with pieces of audio corresponding to imaging positions. According to the above configuration, for example, in a case where a content is a live video of a singer, it is possible to reproduce, for respective channels, videos viewed from positions of different seats and pieces of audio audible at the positions.

The server device in accordance with aspect 4 of the present invention may be configured in one of the aspects 1 through 3 such that: the communication section transmits, to the external device, a video which is encrypted to prohibit recording of the video on the external device. According to the above configuration, recording of a video on an external device is prevented, which contributes to protection of a copyright of a content.

The server device in accordance with aspect 5 of the present invention may be configured in one of the aspects 1 through 4 such that: the content is associated with a plurality of types of identification codes and includes one or more channel videos which are prescribed for each type of identification code; and the communication section transmits, to the external device, a video of any channel among one or more channel videos corresponding to a type of an authenticated identification code. According to the above configuration, it is possible to set, for each type of identification code, a video of a channel which can be downloaded to an external device.

The server device in accordance with aspect 6 of the present invention may be configured in one of the aspects 1 through 5 to further include: a storage section (12) that stores one or more authenticated identification codes and pieces of information for identifying one or more external devices in association with each other, in a case where the acquisition section has acquired a piece of information for identifying an external device, the server device carrying out a process related to authentication using an identification code which is stored in the storage section and is associated with the piece of information for identifying the external device. The above configuration contributes to a configuration in which it is not necessary to input, to an external device, again an identification code which has been successfully authenticated once.

The server device in accordance with aspect 7 of the present invention may be configured in one of the aspects 1 through 6 such that: the acquisition section acquires a single identification code which is associated with a plurality of contents; and at least one of the plurality of contents includes videos of a plurality of channels. According to the above configuration, it is possible to provide a plurality of contents with a single identification code.

The server device in accordance with aspect 8 of the present invention may be configured in one of the aspects 1 through 7 such that: in a case where it has been identified that the external device has a longitudinally-long screen, the communication section transmits, to the external device, a longitudinally-long video for full screen display on the external device. According to the above configuration, it is possible to provide a device configured to be capable of switching to a channel of a longitudinally-long video in a case where the video included in a content associated with an identification code is played.

The server device in accordance with aspect 9 of the present invention may be configured in the aspect 8 such that: the communication section transmits, to the external device, a longitudinally-long video which is associated with audio compatible with immersive audio. According to the above configuration, audio compatible with immersive audio can be enjoyed with a longitudinally-long video, which contributes to improvement in user satisfaction.

The display device (20) in accordance with aspect 10 of the present invention is configured to include: a display section (25); an input section (24) that is used to input an identification code which is associated with a content including videos of a plurality of channels; a communication section (13) that transmits, to a server device (10), the identification code which has been input and information for identifying the display device; and a display control section (211) that, in a case where authentication using the identification code has been carried out, causes the display section to display a first channel video which is included in the content and which has been transmitted from the server device, the display control section, in response to a user operation via the input section, causing the display section to display a second channel video which is included in the content and which has been transmitted from the server device. According to the above configuration, it is possible to provide a device configured to be capable of switching channels of videos in a case where the videos included in a content associated with an identification code are played.

The display device in accordance with aspect 11 of the present invention may be configured in the aspect 10 such that: the display control section causes the display section to display a list of contents which are associated with an authenticated identification code; and the communication section transmits, to the server device, the information for identifying the display device and information for identifying a content which has been selected via the input section from among contents included in the list. According to the above configuration, it is not necessary to input an identification code which has been successfully authenticated once to the input section again, and thus it is possible to reduce labor of a user.

The display device in accordance with aspect 12 of the present invention may be configured in the aspect 10 or 11 such that: the display device plays, using an application installed in the display device, a video which has been transmitted from the server device; and the application prohibits playing of the video in a case where it has been detected that a video recording application or audio recording application is executed on the display device. According to the above configuration, recording of a video on the display device is prevented, which contributes to protection of a copyright of a content.

The display device in accordance with aspect 13 of the present invention may be configured in one of the aspects 10 through 12 such that: the input section includes a camera (241) for reading a two-dimensional code indicating the identification code. According to the above configuration, it is possible to reduce labor of a user to input an identification code.

The control program in accordance with aspect 14 of the present invention is a control program for causing a computer to function as the server device described in one of the aspects 1 through 9, the control program causing the computer to function as the acquisition section and the communication section. According to the above configuration, the above described server device can be implemented by a computer.

The control program in accordance with aspect 15 of the present invention is a control program for causing a computer to function as the display device described in one of the aspects 10 through 13, the control program causing the computer to function as the input section, the communication section, and the display control section. According to the above configuration, the above described display device can be implemented by a computer.

The present invention is not limited to the embodiments described above, but may be altered in various ways by a skilled person within the scope of the claims. Any embodiment derived from a proper combination of technical means disclosed in different embodiments is also encompassed in the technical scope of the present invention.

### REFERENCE SIGNS LIST

1: System
10: Server device
11, 21: Control section
12, 22: Storage section
13, 23: Communication section
20: Display device (external device)
24: Input section
25: Display section
111: Acquisition section
211: Display control section
241: Camera

1. A server device, comprising:
an acquisition section that acquires (i) an identification code which is associated with a content including videos of a plurality of channels and (ii) information for identifying an external device which is a transmission source of the identification code; and
a communication section that transmits, in a case where authentication using the identification code has been carried out, a first channel video included in the content to the external device which has been identified, the communication section transmitting, in response to a user operation via the external device, a second channel video included in the content to the external device.

2. The server device as set forth in claim 1, wherein:
among videos of channels which are transmitted by the communication section, at least two videos differ from each other, and pieces of audio associated with the at least two videos differ from each other.

3. The server device as set forth in claim 2, wherein:
among videos of channels which are transmitted by the communication section, videos of at least two channels have been obtained by imaging a part or whole of a particular subject from different positions and are respectively associated with pieces of audio corresponding to imaging positions.

4. The server device as set forth in claim 1, wherein:
the communication section transmits, to the external device, a video which is encrypted to prohibit recording of the video on the external device.

5. The server device as set forth in claim 1, wherein:
the content is associated with a plurality of types of identification codes and includes one or more channel videos which are prescribed for each type of identification code; and
the communication section transmits, to the external device, a video of any channel among one or more channel videos corresponding to a type of an authenticated identification code.

6. The server device as set forth in claim 1, further comprising:
a storage section that stores one or more authenticated identification codes and pieces of information for identifying one or more external devices in association with each other,
in a case where the acquisition section has acquired a piece of information for identifying an external device, said server device carrying out a process related to authentication using an identification code which is stored in the storage section and is associated with the piece of information for identifying the external device.

7. The server device as set forth in claim 1, wherein:
the acquisition section acquires a single identification code which is associated with a plurality of contents; and
at least one of the plurality of contents includes videos of a plurality of channels.

8. The server device as set forth in claim 1, wherein:
in a case where it has been identified that the external device has a longitudinally-long screen, the communication section transmits, to the external device, a longitudinally-long video for full screen display on the external device.

9. The server device as set forth in claim 8, wherein:
the communication section transmits, to the external device, a longitudinally-long video which is associated with audio compatible with immersive audio.

10. A display device, comprising:
a display section;
an input section that is used to input an identification code which is associated with a content including videos of a plurality of channels;
a communication section that transmits, to a server device, the identification code which has been input and information for identifying said display device; and
a display control section that, in a case where authentication using the identification code has been carried out, causes the display section to display a first channel video which is included in the content and which has been transmitted from the server device, the display control section, in response to a user operation via the input section, causing the display section to display a second channel video which is included in the content and which has been transmitted from the server device.

11. The display device as set forth in claim 10, wherein:
the display control section causes the display section to display a list of contents which are associated with an authenticated identification code; and
the communication section transmits, to the server device, the information for identifying said display device and information for identifying a content which has been selected via the input section from among contents included in the list.

12. The display device as set forth in claim 10, wherein:
said display device plays, using an application installed in said display device, a video which has been transmitted from the server device; and
the application prohibits playing of the video in a case where it has been detected that a video recording application or audio recording application is executed on said display device.

13. The display device as set forth in claim 10, wherein:
the input section includes a camera for reading a two-dimensional code indicating the identification code.

14. A non-transitory computer-readable storage medium storing therein a control program for causing a computer to function as a server device recited in claim 1, the control program causing the computer to function as the acquisition section and the communication section.

15. A non-transitory computer-readable storage medium storing therein a control program for causing a computer to function as a display device recited in claim 10, the control program causing the computer to function as the input section, the communication section, and the display control section.
